(19) United States
(12) Patent Application Publication
(10) Pub. No.: US 2008/0260178 A1
(43) Pub. Date: Oct. 23, 2008

(54) AUDIO SIGNAL TRANSMISSION/RECEPTION DEVICE AND MICROPHONE APPARATUS THEREOF

(75) Inventor: Ryo Tanaka, Hamamatsu-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 12/108,593

(22) Filed: Apr. 24, 2008

Related U.S. Application Data
(63) Continuation of application No. PCT/JP2006/321729, filed on Oct. 31, 2006.

(30) Foreign Application Priority Data
Nov. 2, 2005 (JP) 2005-320043

(51) Int. Cl. H04R 1/00

(52) U.S. Cl. 381/92; 381/355

(57) ABSTRACT

An audio signal transmission/reception device includes a speaker array having a plurality of linearly arranged speaker units and a microphone apparatus having a microphone array having a plurality of linearly arranged microphone units. Some of the microphone units are aligned with equal spacing corresponding to a prescribed distance therebetween in a high-density alignment section, which is set symmetrical to an alignment origin corresponding to a center point of linear alignment. The remaining microphone units are aligned in a low-density alignment section externally of the high-density alignment section in such a way that the spacing therebetween is progressively widened integer times larger than the prescribed distance. Manufacturing costs can be reduced by reducing the total number of the microphone units, and it is possible to improve sound reception directivity with respect to both high and low frequency bands.

### CROSS-REFERENCE TO RELATED APPLICATIONS

This is a continuation application of International Application PCT/JP2006/321729 (published as WO 2007/052645 A1) having an International filing date of 31 Oct. 2006, which claims priority to Japanese Patent Application No. 2005-320043, filed on 2 Nov. 2005. The disclosures of these applications in their entirety are incorporated herein by reference.

### BACKGROUND

1. Field of the Invention

The present invention relates to microphone apparatuses capable of performing sound reception directivity control and in particular to microphone apparatuses applied to audio signal transmission/reception devices integrally including speakers, microphones, and operation controls.

2. Description of the Related Art

Conventionally, telecommunication conferences have been performed, using teleconferencing apparatuses, between remote places via networks and communication lines, wherein it is necessary to precisely receive the speech of a speaker by means of a microphone. For this reason, directional microphones have been used to efficiently receive speech propagated in the direction of a speaker.

In addition, there is provided a microphone apparatus, which uses a line microphone array including a plurality of microphone units and in which prescribed delay times are set to each microphone unit so as to perform directivity control. This is disclosed in Japanese Unexamined Patent Application Publication No. H05-91588, for example.

FIG. 11 shows the exterior structure of a line microphone array. This line microphone array is formed by aligning a plurality of microphone units 500 (i.e., microphone units 500-1 to 500-n) in a linear housing. Herein, the microphone units 500 are aligned with equal spacing d therebetween, so that the overall width of the line microphone array is L.

The microphone units 500 receive plane sound waves (or sound waves of the same phase), which perpendicularly reach in front directions thereof, so that the microphone units 500 output audio signals of the same phase. By mixing audio signals of the same phase, it is possible to increase the audio level. In addition, audio signals of different phases are produced based on sound waves that reach the microphone units 500 in directions other than front directions (e.g., side directions of the line microphone array). When audio signals of different phases are mixed, the audio level is decreased, or they cancel each other out. That is, the sound reception sensitivity of the line microphone array is concentrated into a beam pattern; hence, the main sound reception sensitivity (or the beam-pattern sound reception directivity) is realized only in the front direction.

When audio signals output from the microphone units 500-1 to 500-n are progressively delayed in a prescribed direction, the sound reception direction realizing the maximum level is inclined in response to delay times; hence, it is possible to realize the beam-pattern sound reception directivity in a slanted direction.

As described above, by controlling delay times of audio signals output from the microphone units 500, it is possible to receive sound in a target direction (i.e., it is possible to perform sound reception directivity control).

When the width L of the line microphone array shown in FIG. 11 is increased (i.e., when the number of the microphone units 500 is increased), the sound reception directivity is sharpened; hence, it is possible to set up the beam-pattern sound reception directivity in a target direction. By increasing the width L of the line microphone array, it is possible to perform the sound reception directivity control up to low-frequency bands.

The width L of the line microphone array can be increased by increasing the spacing d without changing the number of the microphone units 500. However, when the spacing d of the microphone units 500 is increased, the beam-pattern sound reception directivity is formed in a direction other than the target direction due to the spatial reflection or spatial foldback phenomenon, whereby it becomes difficult to realize the sound reception directivity control with respect to high-frequency bands. In order to increase the width L of the line microphone array without forming another beam-pattern sound reception directivity, it is necessary to increase the number of the microphone units 500; however, this pushes up manufacturing costs.

In the field of speakers, Japanese Patent No. 3274470 (hereafter the Japanese Reference) teaches an example in which a plurality of speaker units are not aligned with the equal spacing therebetween but are aligned by progressively increasing the spacing from a prescribed origin of alignment. In order to solve the aforementioned problem, a speaker system taught in the Japanese Reference is characterized in that the spacing between the speaker units is broadened from the origin of alignment in a logarithmic manner. That is, the speaker units are aligned in a very high density in proximity to the origin of alignment. However, the spacing between the speaker units proximity to the origin of alignment is limited by the dimensions of speaker units. Since the speaker units cannot be each aligned in a physically overlapping manner, a physical limitation lies in that the speaker units are aligned in contact with each other. Strictly speaking, a frame (or a buffer) is necessary in the periphery of each single speaker unit; hence, it is impossible to actually align the speaker units in contact with each other.

Therefore, the Japanese Reference may allow the width of a speaker array to be broadened while reducing the number of speaker units, whereas it is physically difficult to adequately align the speaker units in a high density in proximity to the origin of alignment. When several speaker units are aligned around the center corresponding to the origin of alignment, the spacing between the speaker units, which are slightly distanced from the origin of alignment, should be rapidly broadened. For this reason, when an alignment method of the speaker array taught in the Japanese Reference is applied to the line microphone array, it is necessary to make consideration with respect to the quality and placement environment of a microphone in order to improve the sound reception directivity control in high-frequency bands without forming other beam-pattern sound reception directivities; hence, it is difficult to realize high sound reception performance.

Accordingly, there remains a need for a transmission/reception device having a sound reception directivity control with improved high-frequency and low frequency bands, and that can be realized with a low manufacturing cost.

### SUMMARY OF THE INVENTION

One aspect of the present invention is an audio signal transmission/reception device. This device can include a speaker array having a plurality of linearly arranged speaker units, and a microphone array having a plurality of linearly arranged microphone units. Some of the microphone units are arranged in a high-density alignment section, which is set symmetrical to an alignment origin corresponding to a center point of linear alignment. The remaining microphone units are aligned in a low-density alignment section outside the high-density alignment section. The microphone units in the high-density alignment section are equally spaced at a prescribed distance between them. The microphone units in the low-density alignment section are spaced at a progressively widening spacing that is set integer times larger than the prescribed distance.

Another aspect of the present invention is a microphone apparatus that can be the microphone array described above.

One feature according to the present invention is that not all microphone units are equally spaced. Some of the microphone units are spaced differently depending on their alignment positions. This is realized by way of the high-density alignment section and the low-density alignment section.

For example, when 16 total microphone units are in the device, 10 of them can be in the high-density alignment section, and the remaining 6 in the low-density alignment section, symmetrically arranged about the alignment center point. If the prescribed spacing (d) can be appropriately determined in response to the environment for using the microphone apparatus. In the low-density alignment section, the spacing is set to an integer multiple of the spacing (d), such as 2d, 3d, and 4d, 3 on each side of the high-density alignment section. As the microphone units are spaced progressively wider in the low-density alignment section, calculating delay times applied to microphone units can be easier and increase the speech processing speed. The spacing (d) in the high-density alignment section is smaller to improve the sound reception directivity with respect to the high-frequency band. The spacing in the low-density alignment section is made wider to increase the overall length L of the microphone array to improve the sound reception directivity with respect to the low frequency band.

Moreover, present configuration of the microphone apparatus makes it possible to reduce the total number of the microphone units to reduce the manufacturing cost, while making it possible to improve the sound reception directivity with respect to both the high frequency band and the low frequency band.

### BRIEF DESCRIPTION OF THE DRAWINGS

FIG. 1 is a perspective view showing the exterior appearance of an audio signal transmission/reception device in accordance with a preferred embodiment of the present invention.

FIG. 2A is a plan view showing the audio signal transmission/reception device in view of X-side and Y-side.

FIG. 2B is a rear view of the audio signal transmission/reception device in view of a −Y-side.

FIG. 2C is a front view of the audio signal transmission/reception device in view of the Y-side.

FIG. 3A is a right-side view of the audio signal transmission/reception device in view of the X-side.

FIG. 3B is a left-side view of the audio signal transmission/reception device in view of a −X-side.

FIG. 4 is a bottom view of the audio signal transmission/reception device, which excludes a lower grill and which arranges a speaker array constituted of a plurality of speakers.

FIG. 5A is a rear view of the audio signal transmission/reception device excluding an upper panel and the lower grill in view of the −Y-side.

FIG. 5B is a front view of the audio signal transmission/reception device excluding the upper panel and the lower grill in view of the Y-side.

FIG. 6 is a perspective view of the audio signal transmission/reception device shown in FIG. 4.

FIG. 7 is a cross-sectional view of the audio signal transmission/reception device shown in FIG. 4 taken along line A-A.

FIG. 8A is an illustration showing mixing of audio signals output based on sound waves arriving in the front direction of the microphone array.

FIG. 8B is an illustration showing realization of a beam-pattern sound reception directivity in a slanted direction.

FIG. 9A is a graph showing the relationship between an inclination angle θ of a beam-pattern sound reception directivity, which is formed when the microphone units are aligned with the equal spacing d therebetween, and a gain G of the microphone array.

FIG. 9B is a graph showing the relationship between the inclination angle θ of a beam-pattern sound reception directivity, which is formed when the microphone units are aligned with equal spacing 4d therebetween and the width L of the microphone array is increased four times, and the gain G.

FIG. 9C is a graph created by reducing a frequency f to one-fourth in FIG. 9A.

FIG. 9D is a graph created by increasing the frequency f eight times in FIG. 9A.

FIG. 10 is an illustration showing the delay control applied to the microphone units in a low-density alignment section of the microphone array.

FIG. 11 is an illustration showing the exterior appearance of a conventionally-known line microphone array.

### DETAILED DESCRIPTION

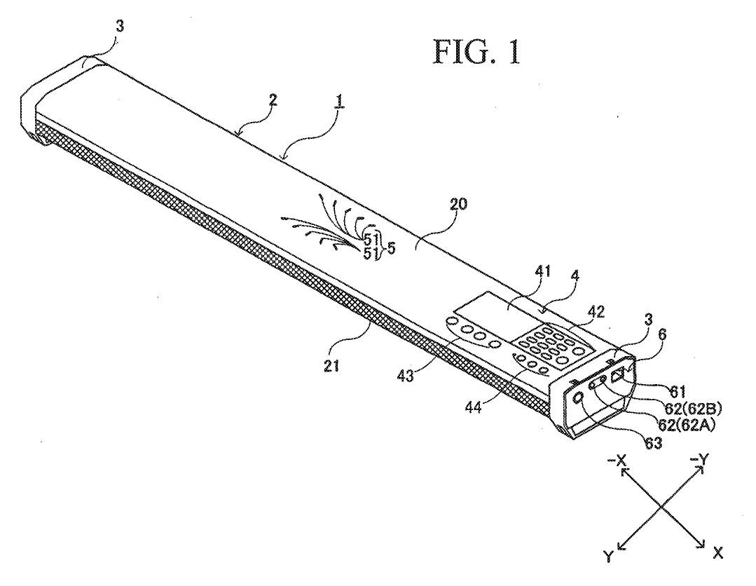

FIG. 1 is a perspective view showing the exterior appearance of an audio signal transmission/reception device 1 in accordance with a preferred embodiment of the present invention. The audio signal transmission reception device 1 is connected to the Internet and LAN (Local Area Network), wherein it performs transmission and reception of audio signals with a counterpart audio signal transmission/reception device (not shown) located at a remote place, thus allowing communications and audio conferences therebetween. A microphone array constituted of a plurality of microphone units is installed in the audio signal transmission/reception device 1, wherein prescribed delay times are applied to the microphone units so as to realize sound reception directivity control.

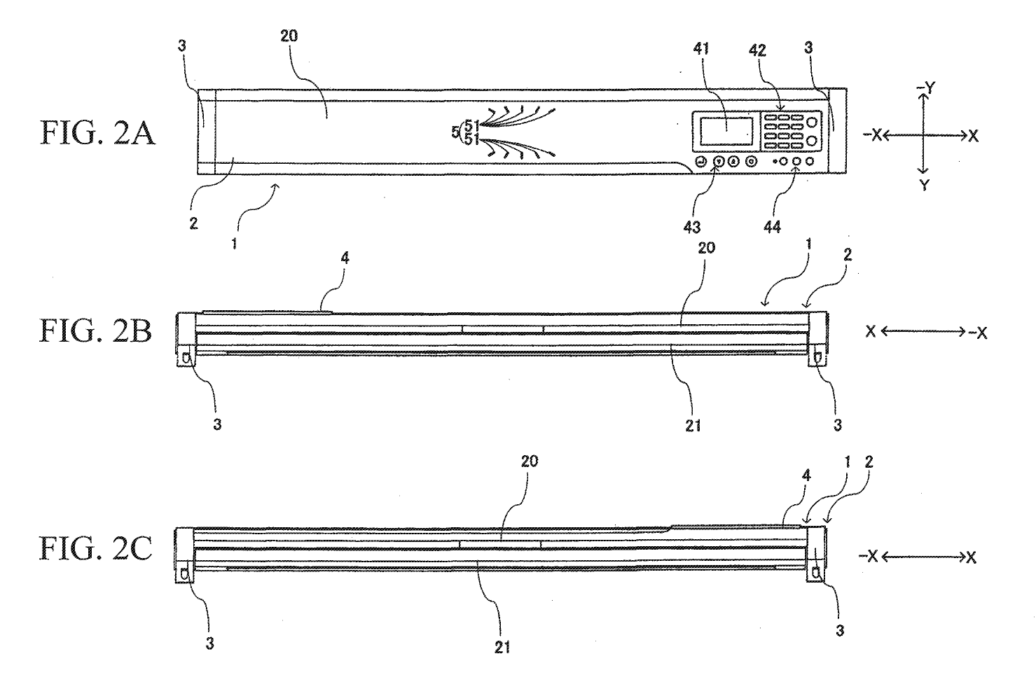

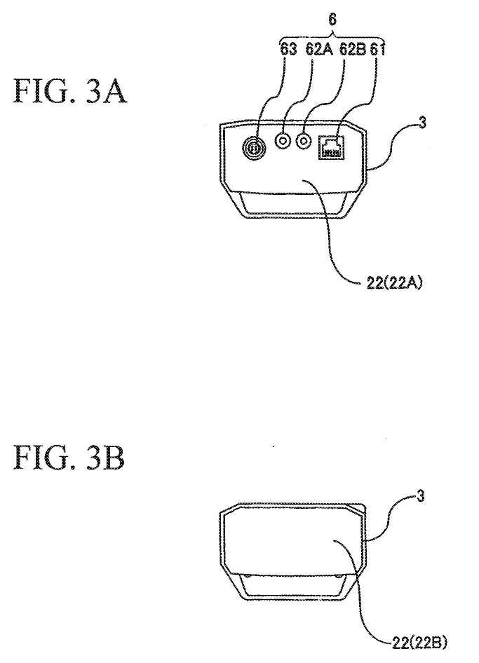

In FIG. 1, the front side of the audio signal transmission/reception device 1 is denoted as a Y-side, the rear side is denoted as a −Y-side, the right side is denoted as an X-side, and the left side is denoted as a −X-side. FIG. 2A is a plan view of the audio signal transmission/reception device 1, FIG. 2B is a rear view of the audio signal transmission/reception device 1 in view of the −Y-side, and FIG. 2C is a front view of the audio signal transmission/reception device 1 in view of the Y-side. FIG. 3A is a right-side view of the audio signal transmission/reception device 1 in view of the X-side; and FIG. 3B is a left-side view of the audio signal transmission/reception device 1 in view of the −X-side.

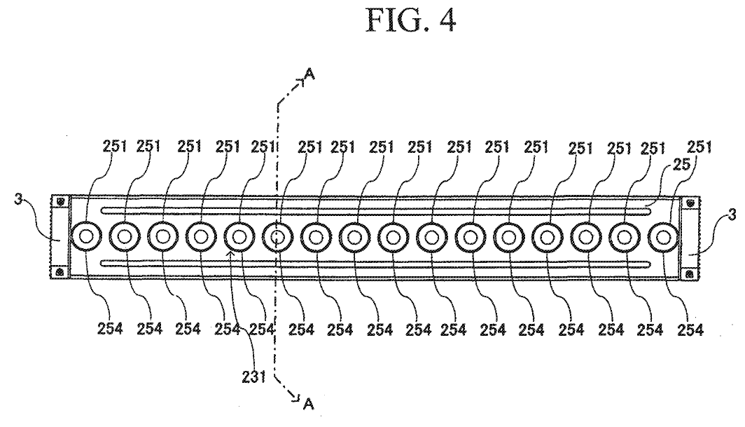

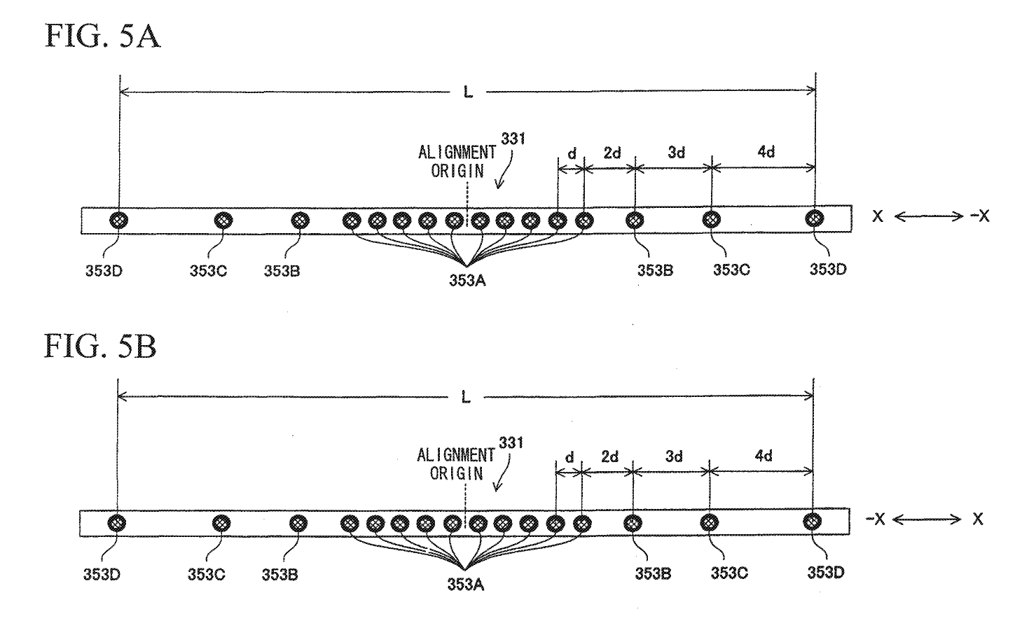

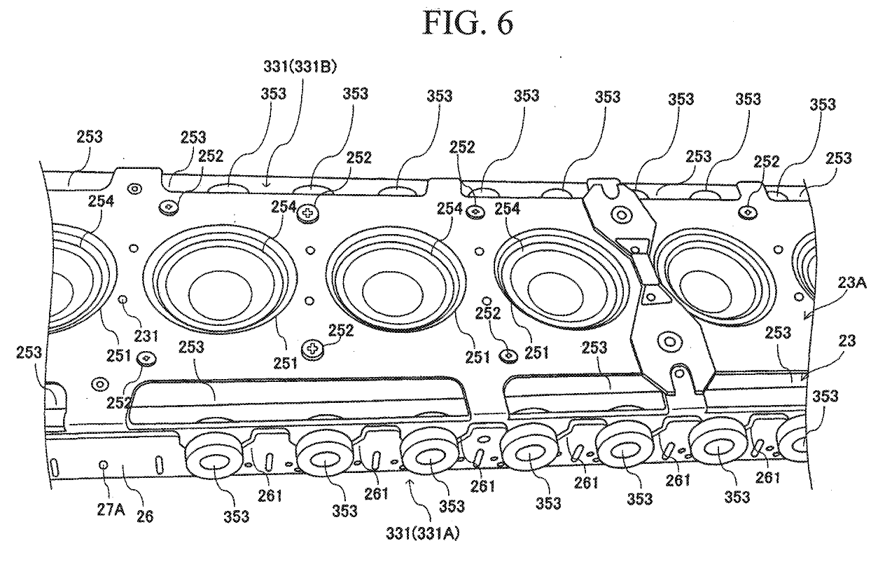

The audio signal transmission reception device 1 is formed using a main unit 2 having an elongated rectangular parallelepiped shape, wherein it is supported above a place surface (e.g., the surface of a desk) at a prescribed height by means of legs 3 having U-shapes, which are engaged with both sides thereof. The main unit 2 has an upper panel 20, a lower grill 21, and a pair of side panels 22 (i.e., 22A and 22B), wherein it is equipped with an elongated speaker device 23 (see FIG. 6) having a speaker array 231 (see FIG. 4) and two lines of microphone arrays 331 (see FIG. 5).

The speaker array 231 is linearly arranged on the lower surface of the speaker device 23 in its longitudinal direction. The microphone arrays 331 are linearly arranged on both sides of the speaker device 23 in its longitudinal direction. Detailed constitutions of the speaker device 23, the speaker array 231, and the microphone arrays 331 will be described later.

The upper panel 20 and the side panels 22 are each formed using a resin and are arranged to cover the internal structure including the speaker array 231 and the microphone arrays 331. The upper panel 20 has an elongated U-shape in its cross section, and the side panel 22 has a substantially planar shape. The lower grill 21 has a U-shape in its cross section so as not to disturb the sound emission of the speaker array 231 and the sound reception of the microphone array 331, wherein it is a punch-mesh steel plate.

An operation control 4 is formed in the X-side of the upper panel 20, and an LED display 5 is formed in the center portion thereof. As shown in FIG. 2A, the operation control 4 arranges an LCD (Liquid Crystal Display) 41 showing the setup condition and operation keys 42 such as a ten-key unit. The operation keys 42 are used for communication control, for example.

In the operation control 4, the LCD 41 and the operation keys 42 are arranged in parallel in the X-side, and other operation keys 43 and 44 are arranged in the Y-side. The operation keys 43 are used to designate up/down of tone volume and a mute operation, while the operation keys 44 are used to change the setup of the audio signal transmission/reception device 1. The audio signal transmission/reception device 1 has two setup modes, wherein it is possible to select one of first and second modes, for example.

In the aforementioned operation control 4, the LCD 41 and the operation keys 42, 43, and 44 are arranged in the Y-side (i.e., the front side of the user) allowing the user to easily view. This makes it possible for the user to easily operate and recognize the audio signal transmission/reception device 1.

The LED display 5 linearly arranges two series of LEDs 51, wherein five LEDs are arranged in the −Y-side, and five LEDs are arranged in the Y-side. In each series, a plurality of LEDs 51 are arranged in a radial manner to be extended from the −X-side to the X-side. The LEDs 51 are each independently controlled by a lighting control section (not shown), which is arranged inside of the upper panel 20. Specifically, when the user operates the operation keys 44 so as to set the first mode, a plurality of LEDs 51 are appropriately controlled to be turned on, thus indicating the directivity of a sound beam emitted from the speaker array 231. That is, the user is capable of visually recognizing the directivity of the sound beam emitted from the speaker array 231 based on the light emissions of the LEDs 51.

When the user operates the operation keys 44 so as to set the second mode, a plurality of LEDs 51 are appropriately controlled to be turned on, thus indicating the sound reception directivity of the microphone array 331. Since two series of the microphone arrays 331 are installed in the main unit 2 of the audio signal transmission/reception device 1, the sound reception directivity of the microphone array 331 in the Y-side is indicated upon the light emissions of the LEDs 51 aligned in the Y-side, while the sound reception directivity of the microphone array 331 in the −Y-side is indicated upon the light emissions of the LEDs 51 aligned in the −Y-side. That is, it is possible for the user to make recognition as to what manner the speech is received by means of the LED display 5. In addition, by observing the light emissions of the two series of LEDs 51, it is possible for the user to recognize the sound reception directivity with respect to two series of microphone arrays 331.

The audio signal transmission/reception device 1 of the present embodiment has functions for controlling the sound reception directivity in a plurality of surrounding areas and for detecting the position of a speaker based on the sound reception level with respect to each area. Thus, it is possible for the user to recognize whether or not the position of a speaker is erroneously detected in the second mode.

In the LED display 5, the light emissions of the LEDs 51 are controlled to vary in response to the received tone volume and the emitted tone volume. Thus, it is possible for the user to recognize whether or not the sound reception and sound emission are made at an adequate tone volume.

As shown in FIG. 3A, connectors 6 are arranged in the side panel 22A in the X-side so as to connect with an external device (not shown). That is, the connectors 6 include a network terminal 61 for connecting with a LAN such as Ethernet (registered trademark) or a network such as the Internet, an audio input terminal 62A and an audio output terminal 62B for connecting with an audio device, and a power terminal 63 for connecting with a power source.

By inserting a plug of a network cable (not shown) into the network terminal 61, the audio signal transmission/reception device 1 can be connected to the network. That is, by connecting the audio signal transmission/reception device 1 to the network, it is possible to communicate with a counterpart audio signal transmission/reception device, thus realizing conversation and audio conference. Thus, it is possible to use the audio signal transmission/reception device 1 as an IP telephone device or an audio conference device.

In the present embodiment, connectors are arranged in the side panel 22A in a concentrated manner. That is, compared with the foregoing audio signal transmission/reception device arranging connectors in its upper surface, the audio signal transmission/reception device 1 of the present embodiment can be more compact.

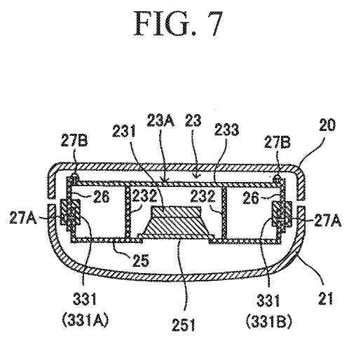

FIG. 4 is a bottom view of the audio signal transmission/reception device 1 excluding the lower grill 21. FIG. 5A is a rear view of the audio signal transmission/reception device 1 excluding the upper panel 20 and the lower grill 21 in view of the −Y-side. FIG. 5B is a front view of the audio signal transmission/reception device 1 in view of the Y-side. FIG. 6 is a perspective view of the audio signal transmission/reception device 1 shown in FIG. 4. FIG. 7 is a cross-sectional view of the audio signal transmission/reception device 1 taken in line A-A in FIG. 4.

The speaker array 231 and the microphone arrays 331 are attached to a frame 25 serving as a baffle of the speaker array 231. The frame 25 is a box-like member, which is formed by bending four corners of a rectangular metal plate upwards. The speaker array 231 is attached to the frame 25 downwardly in its bottom. The microphone arrays 331 are arranged on both sides of the frame 25.

The lower end of an elongated cylindrical frame member 232 is arranged on the upper side of the frame 25 so as to cover the side surfaces of the speaker array 231. A top board 233 whose dimensions substantially match those of the bottom of the frame 25 is arranged on the upper end of the frame member 232.

Support plates 26, which are formed by upwardly extending metal plates, are attached to the side surfaces of the frame 25 (i.e., bent portions lying in its longitudinal direction) via screws 27A. The upper ends of the support plates 26 are bent inwardly. The bent portions of the support plates 26 are attached to end portions of the top board 233 in its width direction via screws 27B. That is, the frame member 232 is held by the top board 233 and the bottom of the frame 25.

As described above, the housing 23A of the speaker array 231 is formed and surrounded by the frame 25, the top board 233, and the cylindrical frame member 232. A substrate (not shown) having a control unit (not shown) for performing directivity control with respect to the speaker array 231 and the microphone arrays 331 is attached to the upper surface of the housing 23A (i.e., the upper surface of the top board 233). The speaker device 23 is constituted of the control unit, the housing 23A, and the speaker array 231.

A plurality of speaker units 254 (e.g., sixteen speakers) are linearly aligned with equal spacing therebetween in the speaker array 231. In this respect, a plurality of holes 251 are correspondingly formed in the bottom of the frame 25 in conformity with the alignment positions of the speaker units 254. Internal diameters of the holes 251 are identical to those of the speaker units 254. That is, the sound emission sides of the speaker units 254 are aligned at the positions of the holes 251. In this state, the speaker array 231 is attached to the bottom of the frame 25 via screws 252. That is, the sound emission side of the speaker array 231 is arranged in the bottom of the frame 25, from which sounds of the speaker units 254 are emitted.

In the present embodiment, the speaker array 231 is arranged in the bottom of the audio signal transmission/reception device 1, and the operation control 4 and the LED display 5 are arranged in the area realizing good user operability (i.e., on the upper surface of the audio signal transmission/reception device 1). That is, by compactly arranging the operation control 4, the LED display 5, and the speaker array 231 in a three-dimensional manner, it is possible to design the audio signal transmission/reception device 1 in compactness. A sound beam emitted from the speaker array 231 is directed downwardly from the audio signal transmission/reception device 1, whereas the audio signal transmission/reception device 1 is supported at a prescribed height from the place surface (e.g., the upper surface of a desk) by means of the legs 3. Accordingly, the sound beam is reflected at the place surface so as to slantingly propagate upwards. That is, it is possible to make a sound beam propagate toward the user with the efficiency similar to the efficiency as the speaker array 231 arranged on the upper surface of the audio signal transmission/reception device 1.

Since the legs 3 have hollow structures, it is possible to make sound propagate toward the user without disturbing the sound emission of the speaker array 231 and the sound reflection at the place surface.

The control unit performs delay, D/A conversion, and audio level amplification on audio signals, which are output from the counterpart audio signal transmission/reception device and are input thereto via the network terminal 61, so that resultant signals are input into the speaker array 231, thus performing the directivity control of a sound beam emitted from the speaker array 231. The control unit controls delay times applied to audio signals input into the speaker units 254, thus performing the directivity control of a sound beam emitted from the speaker array 231.

The microphone arrays 331 are each constituted of a plurality of microphone units 353 (e.g., sixteen microphone units 353) and are linearly aligned on both sides of the frame 25 in its longitudinal direction. The microphone arrays 331 are supported at the opposite sides of the frame 25 by means of the support plates 26, in which cutouts 261 are formed at the positions of the microphone units 353, wherein the support plates 26 are fixed to the frame 25 via screws in such a way that the microphone units 353 are engaged with the cutouts 261.

The sixteen microphone units 353 are aligned symmetrical to an alignment origin corresponding to the center of the alignment in its left and right sides (i.e., they are aligned symmetrically in both of the X-side and the −X-side). As shown in FIGS. 5A and 5B, a prescribed number (e.g., ten) of the speaker units 353A positioned in proximity to the alignment origin are aligned at a high density with equal spacing therebetween, while externally positioned speaker units 353B, 353C, and 353D are aligned so as to increase the spacing therebetween. Specifically, the microphone units 353A are uniformly aligned with the equal spacing d therebetween in a section (hereinafter, referred to as a high-density alignment section) in which ten microphone units 353A are aligned in proximity to the alignment origin. On the other hand, six microphone units 353B, 353C, and 353D are aligned in a section (hereinafter, referred to as a low-density alignment section) externally of (or on both sides of) the high-density alignment section in such a way that the spacing therebetween is increased integer times broader than the aforementioned spacing d toward the external position.

That is, ten microphone units 353A are uniformly aligned with equal spacing d therebetween in the high-density alignment section whose center matches the alignment origin. In the externally positioned low-density alignment section, the microphone unit 353B is positioned adjacent to the microphone unit 353A with the spacing 2d, the microphone unit 353C is positioned adjacent to the microphone unit 353B with the spacing 3d, and the microphone unit 353D is positioned adjacent to the microphone unit 353C with the spacing 4d. That is, in the low-density alignment section, the spacing between the microphone units is progressively broadened in the order as 2d, 3d, and 4d. In other words, the microphone units 353 should be originally aligned with equal spacing therebetween in the microphone array 331, whereas in the low-density alignment section outside the high-density alignment section whose center matches the alignment origin, one microphone unit 353 is omitted in the section of the spacing 2d, two microphone units 353 are omitted in the section of the spacing 3d, and three microphone units 353 are omitted in the section of the spacing 4d. When all the microphone units 353 are aligned with the equal spacing therebetween in the microphone array 331, twenty-eight microphone units are needed, whereas according to the alignment method according to the present embodiment, the total number of the microphone units 353 is only sixteen, making it possible to form the microphone array 331 having the width L sufficiently large as conventional devices, but using a remarkably smaller number of microphone units 353.

The microphone array 331 is connected to the control unit (not shown) of the housing 23A; hence, audio signals, which received and output by the sixteen microphone units 353 in total, are supplied to the control unit. Audio signals are subjected to A/D conversion and are then applied with delay times and are further mixed together, thus performing directivity control. The mixed audio signals are transmitted to the counterpart audio signal transmission/reception device via the network terminal 61 (see FIG. 1).

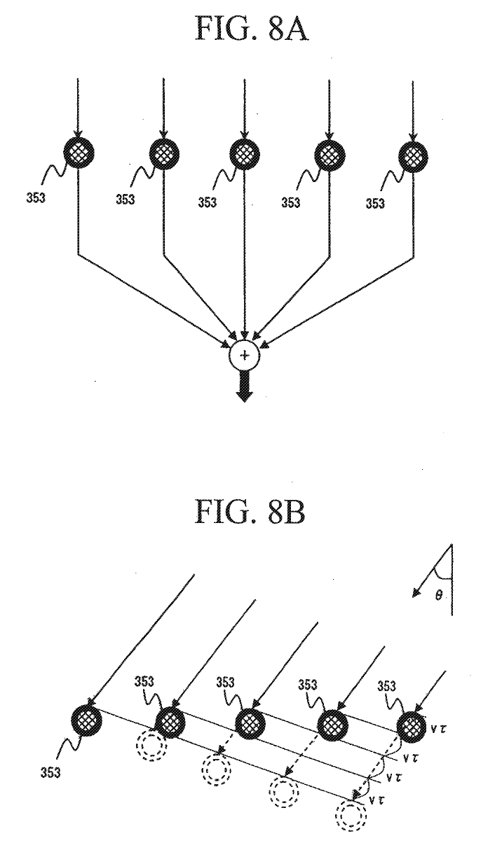

Next, the operating principle of the microphone array will be described with reference to FIGS. 8A and 8B. FIG. 8A shows the state that sound waves reach all the microphone units 353 in their front directions with the same phase. In this state, audio signals output from the microphone units 353 are mixed so as to increase an audio level. On the other hand, the microphone units 353 output audio signals of different phases with respect to sound waves reaching the microphone units 353 in directions other than the front directions. When audio signals of different phases are mixed together, the audio level decreases, or they cancel each other out. That is, the sound reception sensitivity of the microphone array 331 is narrowed down to a beam pattern so that the sound reception sensitivity (i.e., a beam-pattern sound reception directivity) is substantially only in the front direction thereof.

FIG. 8B shows the state that a beam-pattern sound reception directivity is formed in a slanted direction. In this state, the beam-pattern sound reception directivity is inclined in the right side by an angle θ inclined with respect to the front side of the microphone array 331. That is, after sound waves reach the microphone units 353 positioned in the left side in accordance with the beam-pattern sound directivity, sound waves reach the microphone units 353 positioned in the right side in accordance with the beam-pattern sound reception directivity. Thus, every time a time T elapses, audio signals are output in the order from the left-side microphone unit 353 to the right-side microphone unit 353; thus, audio signals output from the microphone units 353 are progressively delayed in the direction from the left to the right, whereby, as shown in FIG. 8B, the beam-pattern sound reception directivity is inclined in response to the delay time.

When the speed of sound is represented as v, the aforementioned inclination angle θ is expressed as sin θ=vτ/d. That is, by controlling the delay time τ, it is possible to control the inclination angle θ of the beam-pattern sound reception directivity.

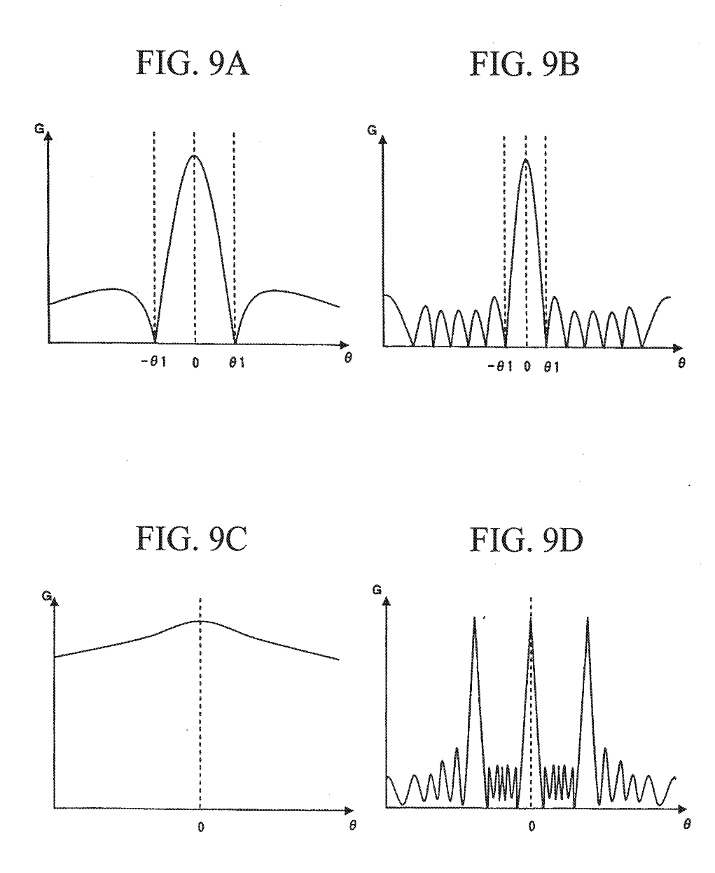

FIG. 9 includes graphs showing examples of inclination angle control methods regarding the beam-pattern sound reception directivity, wherein the horizontal axis represents the inclination angle θ, and the vertical axis represents the gain G of the microphone array 331. FIG. 9A is a graph in which θ=0 is set to a target beam-pattern sound reception directivity and in which the gain G becomes maximum at θ=0. As it departs from θ=0, audio signals output from the microphone units 353 are canceled each other so that the gain G decreases and then becomes zero at θ=±θ1. That is, a range of beam-pattern sound reception directivity corresponding to the width lying from the center of θ=0 realizing the target beam-pattern sound reception directivity to the position, at which the gain G becomes zero, can be represented as θ1=sin⁻¹ (v/fdn) (where f denotes frequency, and n denotes the number of the microphone units 353).

For example, when all the microphone units 353 are aligned with equal spacing d therebetween, the width L of the microphone array 331 is represented as L=d(n−1), wherein the range of beam-pattern sound reception directivity θ1 is determined using the spacing d, the width L, and the frequency f in accordance with the aforementioned equation.

FIG. 9B is a graph, created based on the same condition as FIG. 9A, showing the relationship between the inclination angle θ of the beam-pattern sound reception directivity and the gain G when the spacing between the microphone units 353 is set to 4d, and the width L of the microphone array 331 is increased four times. In FIG. 9B, the range of beam-pattern sound reception directivity becomes small compared with the range of beam-pattern sound reception directivity shown in FIG. 9A; hence, it is possible to realize a sharp beam-pattern sound reception directivity in a target direction. The aforementioned equation shows that, even when the frequency f is increased four times, it is possible to realize the range of beam-pattern sound reception directivity shown in FIG. 9B.

FIG. 9C is a graph, created based on the same condition as FIG. 9A, showing the relationship between the inclination angle θ and the gain G when the frequency f is reduced to one-fourth. In FIG. 9C, there exists no θ1 realizing the gain G of zero. That is, no beam-pattern sound reception directivity is formed. In order to realize the beam-pattern sound reception directivity at the low frequency of f/4, it is necessary to increase the width L of the microphone array 331.

FIG. 9D is a graph, created based on the same condition as FIG. 9A, showing the relationship between the inclination angle θ and the gain G when the frequency f is increased eight times. In FIG. 9D, the beam-pattern sound reception directivity occurs in the direction other than the direction of θ=0. This is caused due to the aforementioned spatial foldback phenomenon, wherein this phenomenon occurs at the frequency matching the relationship of d≧v/2f. In order not to cause the beam-pattern sound reception directivity in the other direction in the high frequency range, it is necessary to reduce the spacing d between the microphone units 353.

As described above, the frequency band realizing the sound reception directivity control of the microphone array 331 of the present embodiment is limited. As shown in FIG. 9C, in the frequency range lower than this frequency band, the beam-pattern sound reception directivity vanishes, while, as shown in FIG. 9D, in the high frequency range, the beam-pattern sound reception directivity occurs in the direction other than the target direction.

When the microphone units 353 are aligned as shown in FIGS. 5A and 5B, a relatively large number (i.e., ten) of microphone units 353A are aligned with the equal spacing d therebetween in the high-density alignment section of the microphone array 331, making it possible to realize sound reception directivity control in the high frequency band without causing the beam-pattern sound reception directivity in the other direction. In the low-density alignment section of the microphone array 331, a relatively small number of microphone units 353 are aligned in order to reduce the manufacturing cost, making it possible to increase the width L and to thereby realize sound reception directivity control in the low frequency band.

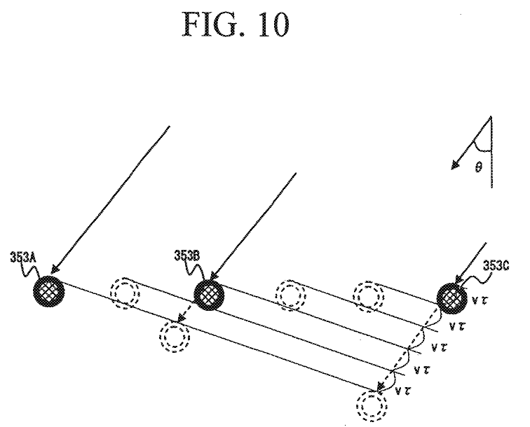

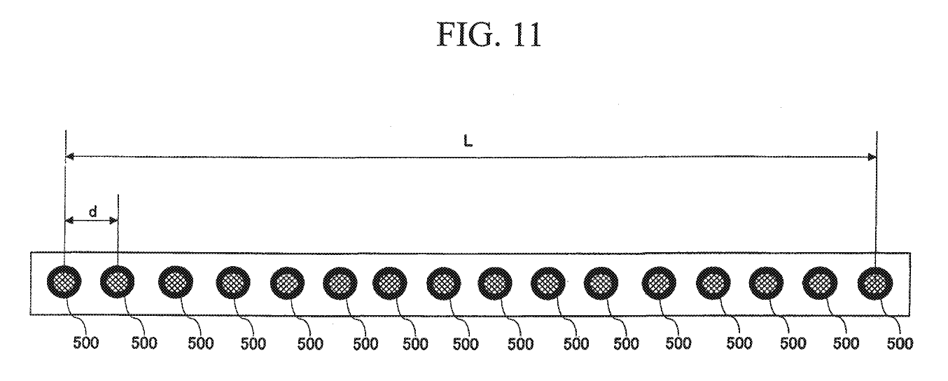

As described above, the sound reception directivity control of the high frequency band does not need an excessively large width L. In this respect, to avoid the spatial foldback phenomenon, however, it is desirable to reduce the spacing d between the microphone units 353. On the other hand, the sound reception directivity control of the low frequency band does not necessarily reduce the spacing d between the microphone units 353. Here, the microphone array 331 needs a relatively large width L. To meet such a tradeoff relationship, the present embodiment employs microphone units 353 that are spaced differently in the low-density alignment section, where the microphone units 353 are spaced progressively wider intervals (i.e., the spacing between the microphone units 353 is broadened integer times). That is, as shown in FIG. 10, to make it easy to control delay times applied to the microphone units 353 in the low-density alignment section, delay times are controlled to be simply increased integer times in the high-density alignment section (or in the equal-spacing alignment section), making it possible to realize high-level signal processing without using complex calculations.

Although the illustrated embodiment has two sets of the microphone arrays 331, only a single set of the microphone array 331 can be incorporated. Moreover, in an alternative embodiment, the speaker array 231 and the microphone array 331 can be arranged in different surfaces of the audio signal transmission/reception device 1. It is possible to arrange both of them on the upper surface or the front surface of the audio signal transmission/reception device 1. The microphone apparatus can be applied to other devices beside audio signal transmission/reception devices for realizing audio conferences in enterprises or between remote places.

While the present invention has been particularly shown and described with reference to preferred embodiments thereof, it will be understood by those skilled in the art that the foregoing and other changes in form and details can be made therein without departing from the spirit and scope of the present invention. All modifications and equivalents attainable by one versed in the art from the present disclosure within the scope and spirit of the present invention are to be included as further embodiments of the present invention. The scope of the present invention accordingly is to be defined as set forth in the appended claims.

What is claimed is:

1. A microphone apparatus comprising:
a plurality of linearly arranged microphone units,
wherein some of the microphone units are arranged in a high-density alignment section, which is set symmetrical to an alignment origin corresponding to a center point of linear alignment,
wherein the remaining microphone units are aligned in a low-density alignment section outside the high-density alignment section,
wherein the microphone units in the high-density alignment section are equally spaced at a prescribed distance between them, and
wherein the microphone units in the low-density alignment section are spaced at a progressively widening spacing that is set integer times larger than the prescribed distance.

2. The microphone apparatus according to claim 1, further including a delay device for each of output signals of the microphone units.

3. An audio signal transmission/reception device comprising:
a speaker array having a plurality of linearly arranged speaker units; and
a microphone array having a plurality of linearly arranged microphone units,
wherein some of the microphone units are arranged in a high-density alignment section, which is set symmetrical to an alignment origin corresponding to a center point of linear alignment,
wherein the remaining microphone units are aligned in a low-density alignment section outside the high-density alignment section,
wherein the microphone units in the high-density alignment section are equally spaced at a prescribed distance between them, and
wherein the microphone units in the low-density alignment section are spaced at a progressively widening spacing that is set integer times larger than the prescribed distance.

4. The audio signal transmission/reception device according to claim 3, further including a delay device for each of output signals of the microphone units.
